(19) United States
(12) Patent Application Publication
(10) Pub. No.: US 2026/0266531 A1
(43) Pub. Date: Sep. 10, 2026

(54) REFRIGERATION APPLIANCE

(71) Applicants: HAIER SMART HOME CO., LTD., Qingdao (CN); QINGDAO HAIER REFRIGERATOR CO., LTD., Qingdao (CN)

(72) Inventors: Changzhi WANG, Qingdao (CN); Enpin XIA, Qingdao (CN); Kang LI, Qingdao (CN)

(21) Appl. No.: 19/105,923

(22) PCT Filed: Aug. 22, 2023
(86) PCT No.: PCT/CN2023/114236

§ 371 Date: Feb. 24, 2025

(30) Foreign Application Priority Data
Aug. 24, 2022 (CN) 202211021212.9

(51) Int. Cl. F25D 23/02

(52) U.S. Cl. CPC F25D 23/02

(57) ABSTRACT

The present application discloses a refrigeration appliance includes: a cabinet, a door mounted on the cabinet, and a panel mounted on a front side of the door; mounting grooves are provided on the door, the mounting groove has an upper wall and a lower wall; the door also has positioning protrusions; an overlap portion is formed on each the lower wall of the mounting groove; a plurality of mounting members matching with the mounting grooves are provided on the panel, and positioning slots are provided on the mounting members. The embodiment of the present application facilitates alignment between the mounting members on the panel and the positioning slots, making door installation more convenient.

### CROSS REFERENCE TO RELATED APPLICATIONS

This application is a National Stage of International Application No. PCT/CN2023/114236 filed on Aug. 22, 2023, which claims priority to Chinese Patent Application No. 202211021212.9, filed on Aug. 24, 2022. The entire contents of the above-mentioned patent applications are incorporated herein by reference.

### TECHNICAL FIELD

The present application relates to the field of refrigeration technology, particularly to refrigeration appliances.

### BACKGROUND

Refrigerator appliance is a widely used household appliance. With the improvement of people's living standards, users have higher requirements for the appearance of refrigerators. In the prior art, to ensure the aesthetics and diversity of refrigerator door panels, the panel and the door are typically designed as separate components, with the panel being mounted on the door.

In the existing structural designs, the panel is not only difficult to install, but the fasteners are also easily exposed on the panel after installation, affecting the aesthetic appearance.

Reference to any prior art in the specification is not, and should not be taken as, an acknowledgment or any form of suggestion that this prior art forms part of the common general knowledge in Europe or any other jurisdiction or that this prior art could reasonably be expected to be understood and regarded as relevant by a person skilled in the art.

### SUMMARY

The object of the present application is to provide a refrigeration appliance to address the deficiencies in the prior art, which enables the lateral mounting plate positioned in the mounting groove to be more conveniently operated when being fixed to the side wall, and since the panel is mounted on the side wall of the mounting groove through the lateral mounting plate, the panel can cover the fasteners from the front side after installation, thereby improving the aesthetic appearance of the front side of the refrigeration appliance.

The present application provides a refrigeration appliance, comprising: a cabinet, a door mounted on the cabinet, and a panel mounted on a front side of the door;
wherein a plurality of mounting grooves are provided on the door and open toward the panel, and a lateral opening is provided on a side of the door to expose the mounting grooves; the mounting groove has a side wall opposite to the lateral opening;
wherein a plurality of mounting members are provided on a side of the panel facing the door, the mounting members are positioned in the mounting grooves and have lateral mounting plates opposite to the side walls, and the lateral mounting plates are fixed to the side walls.

Furthermore, wherein door-mounting holes are provided on the side walls, mounting plate-mounting holes matching with the door-mounting holes are provided on the lateral mounting plates; the mounting plate-mounting holes are opposite to the lateral openings; the lateral mounting plates are fixed to the side walls by fasteners, and the fasteners are simultaneously positioned in the door-mounting holes and the mounting plate-mounting holes.

Furthermore, wherein the mounting groove has an upper wall and a lower wall oppositely arranged in an up-down direction; the mounting member has a bottom plate supported on the lower wall, and positioning protrusions are provided on the lower wall, and positioning slots matching with the positioning protrusions are provided on the bottom plate.

Furthermore, wherein a portion of the lower wall of the mounting groove located at a front side of the positioning protrusion forms an overlap portion, and a plane where the overlap portion is located extends horizontally.

Furthermore, wherein the positioning protrusion has an inclined guide portion inclined toward an opening direction of the mounting groove, and a height of the inclined guide portion gradually increases away from the opening of the mounting groove.

Furthermore, wherein a dimension from a top of the lateral mounting plate to the upper wall is not less than a distance from a top of the positioning protrusion to the lower wall.

Furthermore, wherein the mounting member further has lateral support portions provided on opposite sides of the bottom plate, and a pair of lateral limiting portions are provided in the mounting groove to be opposite to the lateral support portions and limit the lateral support portions in a left-right direction;
wherein the lateral support portion includes a connecting plate provided on one side of the bottom plate and a transverse support plate provided on the connecting plate, the connecting plate is configured to abut against a side wall of the lateral limiting portion, and the transverse support plate is supported on a top of the lateral limiting portion;
wherein the connecting plate is fixedly connected with the lateral mounting plate;
wherein arcuate transition portions are provided between the bottom plate and the connecting plate, and between the connecting plate and the transverse support plate;
wherein the bottom plate, the connecting plate and the transverse support plate are integrally formed.

Furthermore, wherein the door includes a door main body and upper and lower beams provided on top and bottom of the door main body; bolts extending in an up-down direction are provided on both the upper beam and the lower beam;
wherein the panel further has upper and lower connecting plates oppositely arranged in the up-down direction on a side facing the door, both the upper and lower connecting plates have connecting plate positioning holes; the connecting plate positioning holes match with the bolts; wherein a pair of nuts are provided on the bolt, and the connecting plate is clamped and fixed by the pair of nuts.

Furthermore, wherein the door includes a door main body and a door-mounting member provided on the door main body, the mounting grooves are provided on the door-mounting member, and the door-mounting member is integrally injection molded; wherein the lateral opening is provided on the door-mounting member, and the refrigeration appliance further has decorative strips provided on left and right sides of the door main body, decorative strip-mounting members are provided on a side of the decorative strips facing the door main body, the decorative strip-mounting members are opposite to the lateral openings and positioned on the door-mounting member; wherein decorative strip positioning slots are provided on the decorative strip-mounting members at positions of the lateral openings, opening directions of the decorative strip positioning slots are perpendicular to opening directions of the mounting grooves, and the decorative strip positioning slots are exposed toward the mounting grooves; the decorative strip-mounting members have elastic snap feet engaged in the decorative strip positioning slots.

Furthermore, wherein the decorative strips further have elastic engagement members on a side facing the door main body, positioning holes matching with the elastic engagement members are provided on the door main body, the elastic engagement member includes an engagement main body positioned on the decorative strip and a plurality of elastic snap feet provided on the engagement main body, the plurality of elastic snap feet are arranged in a ring shape on the engagement main body and have a first state where they converge toward each other and accumulate resilient force.

Compared with the prior art, the present application provides mounting grooves that open toward the front side on the door and lateral openings toward the door sides, which enables the lateral mounting plate positioned in the mounting groove to be more conveniently operated when being fixed to the side wall, and since the panel is mounted on the side wall of the mounting groove through the lateral mounting plate, the panel can cover the fasteners from the front side after installation, thereby improving the aesthetic appearance of the front side of the refrigeration appliance.

As used herein, except where the context clearly requires otherwise, the term “comprise” and variations of the term, such as “comprising”, “comprises” and “comprised”, are not intended to exclude further features, components, integers or steps.

### BRIEF DESCRIPTION OF THE DRAWINGS

FIG. 1 is a structural diagram of the refrigeration appliance according to an embodiment of the present application.

FIG. 2 is an exploded view of the refrigeration appliance according to an embodiment of the present application.

FIG. 3 is an enlarged view of area A in FIG. 2.

FIG. 4 is a top view of the refrigeration appliance according to an embodiment of the present application;

FIG. 5 is a sectional view along direction CC in FIG. 4.

FIG. 6 is an enlarged view of area B in FIG. 5.

FIG. 7 is a structural diagram of the refrigeration appliance with the panel removed according to an embodiment of the present application.

FIG. 8 is a structural diagram of the panel of the refrigeration appliance according to an embodiment of the present application.

FIG. 9 is a first structural diagram of the door-mounting member of the refrigeration appliance according to an embodiment of the present application.

FIG. 10 is a front view of the door-mounting member of the refrigeration appliance according to an embodiment of the present application.

FIG. 11 is a first structural diagram of the mounting member of the refrigeration appliance according to an embodiment of the present application.

FIG. 12 is a second structural diagram of the mounting member of the refrigeration appliance according to an embodiment of the present application.

FIG. 13 is a front view of the mounting member of the refrigeration appliance according to an embodiment of the present application.

FIG. 14 is a structural diagram of the decorative strip of the refrigeration appliance according to an embodiment of the present application.

FIG. 15 is a structural diagram of the elastic engagement member of the refrigeration appliance according to an embodiment of the present application.

FIG. 16 is a structural diagram of the decorative strip-mounting member of the refrigeration appliance according to an embodiment of the present application.

Reference Numerals: 1—door, 10—mounting groove, 11—upper wall, 12—lower wall, 13—positioning protrusion, 14—overlap portion, 15—lateral limiting portion, 16—lateral opening, 17—side wall, 170—door-mounting hole, 2—panel, 3—mounting member, 30—positioning slot, 31—bottom plate, 32—lateral support portion, 321—connecting plate, 322—transverse support plate, 33—mounting-fixing plate, 34—reinforcing rib, 35—lateral mounting plate, 350—mounting plate—mounting hole, 4—decorative strip, 41—decorative strip—mounting member, 411—upper positioning portion, 412—lower positioning portion, 42—decorative plate, 43—elastic engagement member, 431—engagement main body, 432—elastic snap foot, 44—magnetic member, 45—front cover plate, 5—upper connecting plate, 100—door main body, 1001—upper beam, 1002—nut, 1003—bolt, 110—door-mounting member, 1101—upper positioning slot, 1102—lower positioning slot, 1103—first limiting protrusion, 1104—second limiting protrusion.

### DETAILED DESCRIPTION OF EMBODIMENTS

In the description of this utility model, it should be understood that terms such as “center”, “longitudinal”, “transverse”, “up”, “down”, “front”, “rear”, “left”, “right”, “vertical”, “horizontal”, “top”, “bottom”, “inner”, “outer” indicating directional or positional relationships are based on the directional or positional relationships shown in the drawings, are merely for the convenience of describing this utility model and simplifying the description, and do not indicate or imply that the referred device or element must have a specific orientation, be constructed in a specific orientation, or operate in a specific orientation, therefore should not be construed as limitations of this utility model.

Furthermore, terms “first” and “second” are used only for descriptive purposes and should not be understood as indicating or implying relative importance.

In the description of this utility model, it should be noted that unless otherwise explicitly specified and limited, terms such as “mounted”, “position”, “connected” should be broadly understood. For example, they can refer to fixed connection, integral connection, or detachable connection; mechanical connection or electrical connection, or internal communication between two elements; direct connection or indirect connection through intermediate media. Those skilled in the art can understand the specific meanings of these terms based on specific circumstances.

The embodiments described below with reference to the drawings are exemplary and are only used to explain the present application, and should not be construed as limitations of the present application.

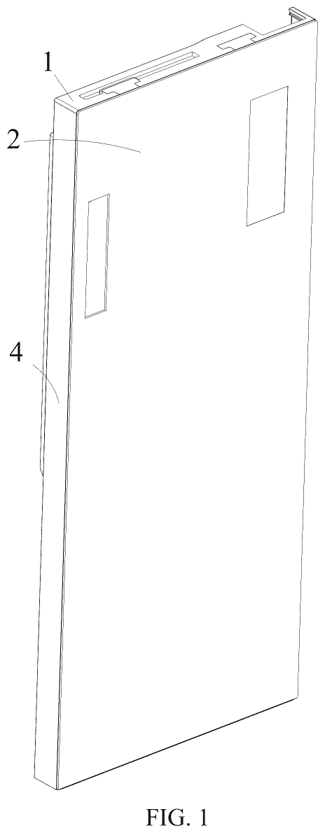

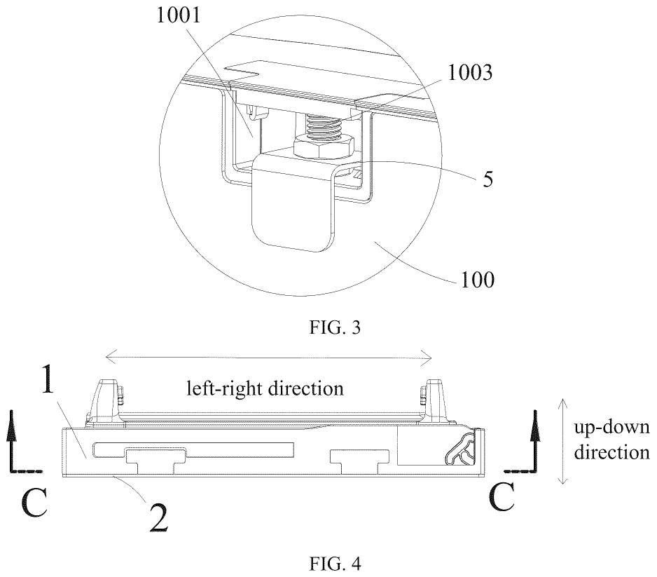

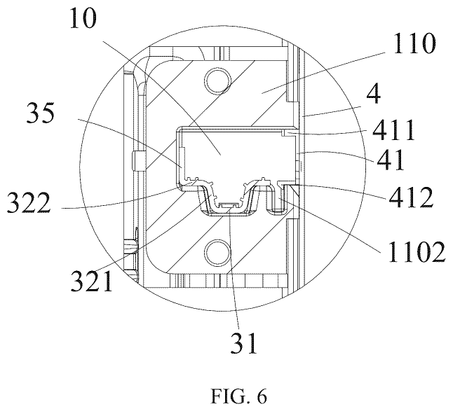

Embodiments of the present application: As shown in FIGS. 1-6, a refrigeration appliance is disclosed. The refrigeration appliance can be a refrigerator, including: a cabinet, a door 1 mounted on the cabinet, and a panel 2 mounted on the front side of the door 1. The panel 2 is mounted and fixed on the front side of the door 1 to form a decoration of the door 1. In specific embodiments, the panel 2 can be a stone panel, glass panel, or other decorative panel fixed on the door 1. The above structure allows the panel 2 to be separate from the door 1, enabling users to replace and select corresponding panels 2 according to their actual needs, thus meeting users' diverse requirements. The panel 2 can also be designed with patterns matching indoor decoration styles, thereby enhancing aesthetics.

The above structure requires the panel 2 to be conveniently mounted and fixed on the door 1, therefore how to configure the panel 2 for convenient installation, fixing, or removal is an important issue.

In this embodiment of the refrigeration appliance, which has a door 1 and a panel 2 mounted on the door 1, a plurality of mounting grooves 10 are provided on the door 1 opening toward the front side. It can be understood that since the panel 2 is mounted on the front side of the door 1, the mounting grooves 10 also open toward the panel 2, and the mounting grooves 10 have upper walls 11 and lower walls 12 oppositely arranged in the up-down direction.

The door 1 also has positioning protrusions 13 provided on the lower walls 12; portions of the lower walls 12 of the mounting grooves 10 located at the front side of the positioning protrusions 13 form overlap portions 14; the planes where the overlap portions 14 are located extend horizontally and the overlap portions 14 are positioned near the openings of the mounting grooves 10. The overlap portion 14 is actually a part of the lower wall 12. After the mounting member 3 fixed on the panel 2 aligns with the mounting groove 10, the mounting member 3 can first be supported on the overlap portion 14, then the panel 2 can be pushed horizontally to achieve installation and fixing of the mounting member 3 in the mounting groove 10.

A plurality of mounting members 3 matching with the mounting grooves 10 are provided on the side of the panel 2 facing the door 1, and positioning slots 30 matching with the positioning protrusions 13 are provided on the mounting members 3.

In this embodiment, the mounting grooves 10 opening toward the front side facilitate the alignment of mounting members 3 on the panel 2 with the mounting grooves 10, thus making it more convenient to position the mounting members 3 in the mounting grooves 10 for installing and fixing the panel 2. With the overlap portions 14 extending horizontally provided near the openings on the lower walls 12 of the mounting grooves 10, during installation, the mounting members 3 on the panel 2 first align with the positioning slots 30, then the mounting members 3 overlap with the overlap portions 14, and the panel 2 can be installed and fixed on the door 1 by pushing horizontally, which is more convenient than installing and fixing the panel through oblique insertion.

In this embodiment, positioning protrusions 13 are also provided, which work with positioning slots 30 on the mounting members 3 to achieve installation and fixing of the mounting members 3 in the positioning slots 30. Since the positioning protrusions 13 affect the horizontal pushing installation of the panel 2, to reduce this impact, the positioning protrusions 13 in this embodiment have inclined guide portions that are inclined toward the opening direction of the mounting grooves 10, and the height of the inclined guide portions gradually increases away from the openings of the mounting grooves 10.

The provision of inclined guide portions enables smoother installation and positioning of the panel 2 in the mounting grooves 10. It can be understood that since the height of the inclined guide portions gradually increases away from the openings of the mounting grooves 10, the panel 2 will relatively move upward or jump up on the inclined guide portions before being fully installed and fixed. Therefore, to prevent the panel 2 from being blocked during upward movement or jumping, the dimension from the top of the mounting member 3 to the upper wall 11 is not less than the distance from the top of the positioning protrusion 13 to the lower wall 12.

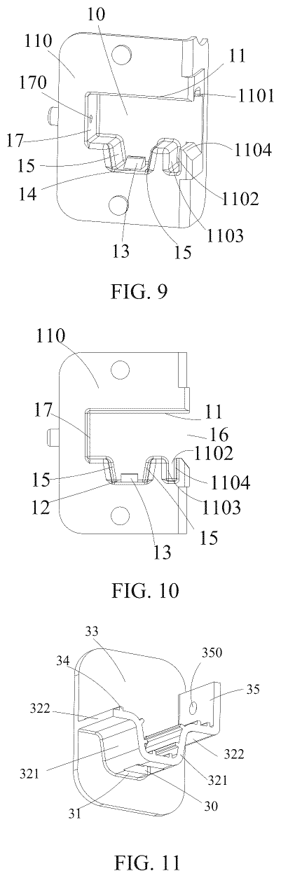

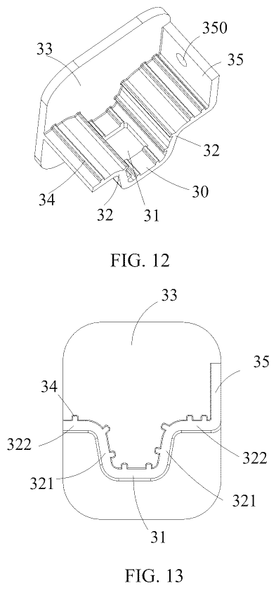

As shown in FIGS. 9-13, in this embodiment, the mounting member 3 has a bottom plate 31 opposite to the lower wall 12 and lateral support portions 32 provided on opposite sides of the bottom plate 31. The positioning slot 30 is provided on the bottom plate 31, and a pair of lateral limiting portions 15 are provided in the mounting groove 10 opposite to the lateral support portions 32 to limit the lateral support portions 32 in the left-right direction. The provision of lateral limiting portions 15 enables better positioning of the panel 2 in the left-right direction.

The lateral support portion 32 includes a connecting plate 321 provided on one side of the bottom plate 31 and a transverse support plate 322 provided on the connecting plate 321. The connecting plate 321 is configured to abut against the side wall of the lateral limiting portion 15, and the transverse support plate 322 is supported on the top of the lateral limiting portion 15. The plane where the transverse support plate 322 is located is different from the plane where the bottom plate 31 is located, with the plane of the transverse support plate 322 being higher than that of the bottom plate 31. The plane of the transverse support plate 322 is parallel to the plane of the bottom plate 31, while the connecting plate 321 extends obliquely relative to the horizontal plane.

In this embodiment, a pair of lateral support portions 32 are symmetrically provided on opposite sides of the bottom plate 31. This structure allows both the lower wall 12 and the lateral limiting portions 15 to support the mounting member 3, increasing the supporting areas. Specifically, the supporting areas for the mounting member 3 include the bottom plate 31 and the transverse support plates 322 provided on both sides of the bottom plate 31, with the bottom plate 31 and transverse support plates 322 being on different horizontal planes. This structure not only increases the supporting area but also provides better support effect. Since the bottom plate 31 and transverse support plates 322 are on different horizontal planes, they also provide some support and limitation to the panel 2 in the up-down direction, preventing the panel 2 from front-back rotation.

The mounting member 3 disclosed in this embodiment enables the panel 2 to be stably supported in the mounting groove 10 and limits the mounting member 3 in the left-right direction, thereby avoiding wobbling of the mounting member 3 and providing higher stability after installation.

As shown in FIGS. 11-13, arcuate transition portions are provided between the bottom plate 31 and the connecting plate 321, and between the connecting plate 321 and the transverse support plate 322. The arcuate transition portions make the transitions between the connecting plate 321 and bottom plate 31, and between the transverse support plate 322 and connecting plate 321 smoother, enabling smoother pushing of the mounting member 3 into the mounting groove 10.

In this embodiment, the bottom plate 31, connecting plate 321, and transverse support plate 322 are integrally formed. The mounting member 3 can be a plastic part, with the bottom plate 31, connecting plate 321, and transverse support plate 322 being integrally injection molded. The integral formation enhances the strength of the entire mounting member 3, thereby providing better support for the panel 2.

Furthermore, to better achieve installation and fixing of the mounting member 3 on the panel 2, the mounting member 3 also has a mounting-fixing plate 33 fixed on the panel 2. The mounting-fixing plate 33 is fixedly attached to the panel 2, and the bottom plate 31 and lateral support portions 32 are all provided on the side of the mounting-fixing plate 33 away from the panel 2.

Furthermore, as shown in FIGS. 11-13, to enhance the supporting strength of the mounting member 3, several reinforcing ribs 34 extending in the front-back direction are provided on the side of the mounting member 3 away from the lower wall 12. Multiple reinforcing ribs 34 are provided, arranged parallel to and spaced from each other on the mounting member 3. In another embodiment, the reinforcing ribs 34 can also be divided into two parallel groups intersecting obliquely to form a grid structure.

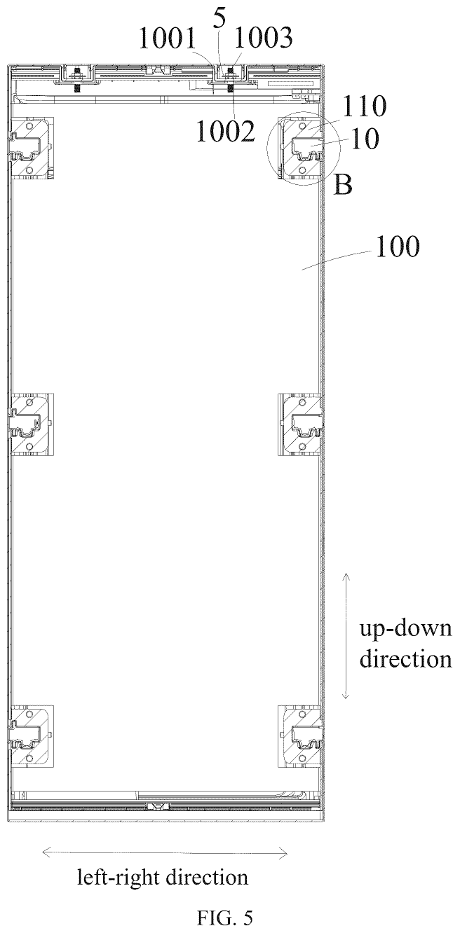

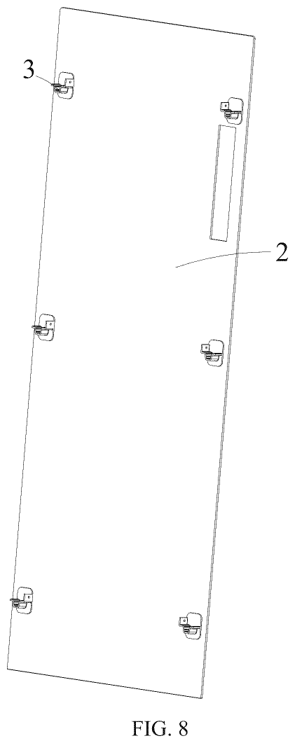

As shown in FIGS. 5-10, in this embodiment, the door 1 includes a door main body 100 and several door-mounting members 110 provided on the door main body 100. The mounting grooves 10 are provided on the door-mounting members 110, which are integrally injection molded, and the mounting grooves 10 are formed during the molding process of the door-mounting members 110.

The door main body 100 includes an outer shell and an inner liner provided on the outer shell, with a foam layer formed between the inner liner and outer shell. Mounting holes matching with the door-mounting members 110 are provided on the outer shell, and the door-mounting members 110 are pressed against the outer shell during the formation of the foam layer.

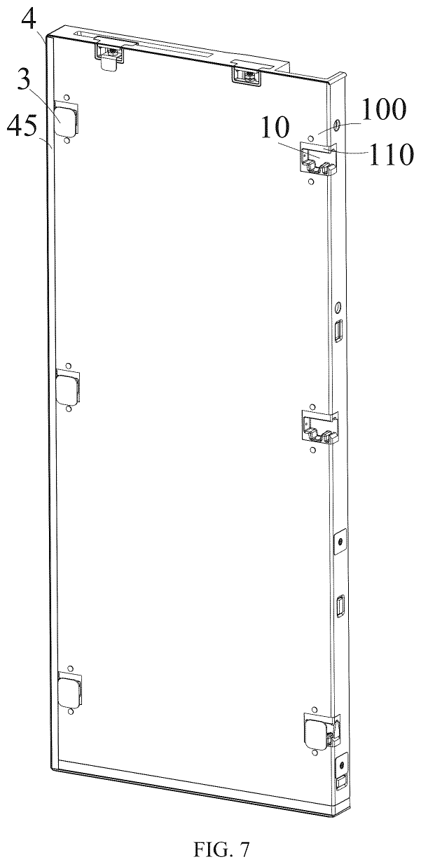

As shown in FIG. 7, multiple door-mounting members 110 are provided on one door 1, divided into two groups and arranged on both sides of the door main body 100, and the door-mounting members 110 are positioned at the left and right edges of the door main body 100, with the door-mounting members 110 exposed from the side of the door main body 100.

In the above embodiment, the mounting member 3 is installed and fixed in the mounting groove 10 only through the engagement between the positioning protrusion 13 and the positioning slot 30 on the bottom plate 31. As shown in FIGS. 5-10, to better achieve the installation and fixing of the mounting member 3 in the mounting groove 10, the door 1 has lateral openings 16 exposing the mounting grooves 10 on its sides; the mounting groove 10 has side walls 17 opposite to the positions of the lateral openings 16. Specifically, the lateral openings 16 are provided on the door-mounting members 110, and the side walls 17 are positioned opposite to the lateral openings 16 in the left-right direction and on opposite sides of the mounting groove 10.

As shown in FIGS. 11-13, the mounting member 3 also has lateral mounting plates 35 positioned opposite to the side walls 17, and the lateral mounting plates 35 are fixed to the side walls 17. The lateral mounting plates 35 are fixed to the transverse support plates 322 and integrally formed with the transverse support plates 322, with the planes of the lateral mounting plates 35 extending in the up-down direction.

Door-mounting holes 170 are provided on the side walls 17, and mounting plate-mounting holes 350 matching with the door-mounting holes 170 are provided on the lateral mounting plates 35; the mounting plate-mounting holes 350 are positioned opposite to the panel lateral openings 16; the mounting plate holes 350 are exposed to the outside through the lateral openings 16, and the lateral mounting plates 35 are fixed to the side walls 17 by fasteners, with the fasteners simultaneously positioned in both the door-mounting holes 170 and the mounting plate-mounting holes 350.

In this embodiment, the door-mounting holes 170 are threaded holes, and the fasteners include bolts threaded into the threaded holes and nuts provided on the bolts. The nuts press against the lateral mounting plates 35 and clamp the lateral mounting plates 35 firmly to the side walls 17.

In this embodiment, providing lateral openings 16 on the door-mounting members 110 makes it more convenient to operate the fasteners for installation and fixing on the door 1. The lateral openings 16 expose the door-mounting holes 170 from the side direction of the door, making it convenient to install and fix the fasteners in the door-mounting holes 170.

Fixing the lateral mounting plates 35 to the side walls 17 with fasteners avoids exposure of mounting components on the front side. After installing and fixing the lateral mounting plates 35 with fasteners, the fasteners are covered by the panel 2, so only the panel is visible from the front direction, improving aesthetics compared to existing solutions where fasteners are exposed on the front side of the panel 2.

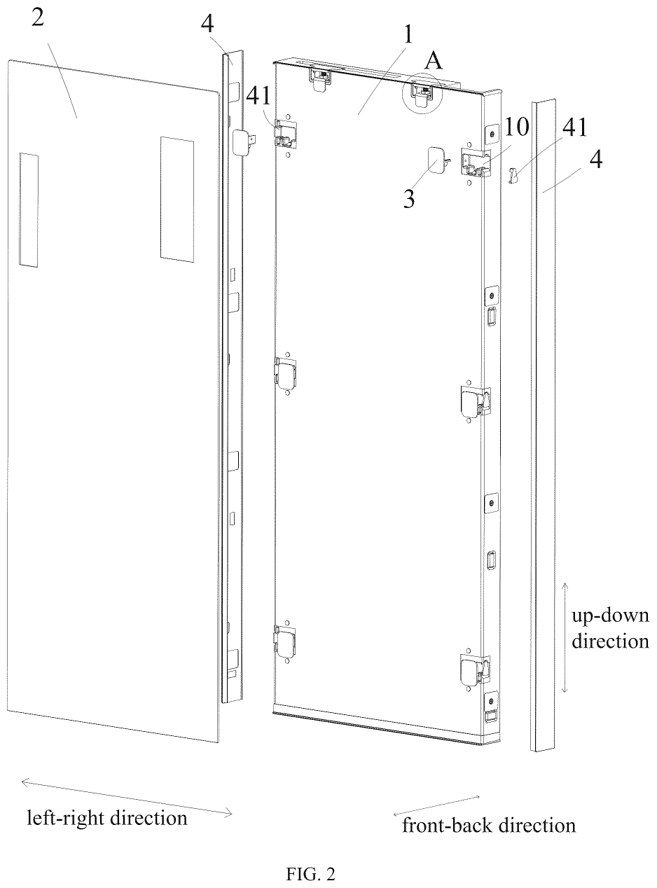

As shown in FIG. 2, the refrigeration appliance also has decorative strips 4 provided on both left and right sides of the door 1. Decorative strip-mounting members 41 are provided on the side of the decorative strips 4 facing the door main body 100. The decorative strip-mounting members 41 are positioned opposite to the lateral openings 16 and positioned at the lateral openings 16. Specifically, the decorative strip-mounting members 41 are positioned on the door-mounting members 110.

Installing and fixing the decorative strips 4 on the side of the door 1 through decorative strip-mounting members 41, while utilizing the lateral openings 16, reduces the number of openings on the door 1. Since the lateral openings 16 are integrally formed during the molding of the door-mounting members 110, they are easier to manufacture, simplifying the process while facilitating the assembly of decorative strips 4. Additionally, the decorative strip-mounting members 41 can provide some coverage for the lateral openings 16, and while covering the lateral openings, they can also compensate for the reduction in door thickness caused by the mounting grooves 10, thereby reducing the decline in thermal insulation performance caused by the reduced door thickness.

In this embodiment, the decorative strip-mounting members 41 are engaged with the door-mounting members 110. Using an engagement method makes it convenient to replace and disassemble the decorative strips 4, allowing for replacement according to user requirements.

The door-mounting member 110 has upper positioning slots 1101 and lower positioning slots 1102 provided on the upper and lower sides of the lateral opening 16 respectively.

As shown in FIGS. 5-7, the decorative strip-mounting member 41 is provided with an upper positioning portion 411 that cooperates with the upper positioning slot 1101 to limit the decorative strip 4 in the front-back direction, and a lower positioning portion 412 that cooperates with the lower positioning slot 1102 to limit the decorative strip 4 in the left-right direction.

First limiting protrusions 1103 and second limiting protrusions 1104 are provided on the door-mounting member 110 at the position of the lateral opening, arranged opposite to each other in the left-right direction. The lower positioning slot 1102 is formed between the first limiting protrusion 1103 and second limiting protrusion, and the lower positioning slot 1102 is exposed toward the mounting groove 10.

The lower positioning portion 412 includes elastic snap feet with hook-shaped portions that are positioned in the lower positioning slot 1102 and abut against the second limiting protrusion 1104.

The upper positioning slot 1101 opens toward the decorative strip 4 and is exposed toward the mounting groove 10. The upper positioning portion 411 matches with the upper positioning slot 1101 and can be snap-fitted into the upper positioning slot 1101.

The decorative strip 4 has a decorative plate 42 covering the side of the door 1, and the decorative strip-mounting member 41 is integrally formed on the decorative plate 42. The decorative strip 4 can be made of plastic or aluminum alloy. Making the decorative strip 4 from plastic or aluminum alloy and integrally forming the decorative strip-mounting member 41 on the decorative plate 42 ensures more stable installation of the decorative strip 4 on the door 1, avoiding large gaps between the decorative strip 4 and the door 1 when laterally engaged.

The decorative strip 4 also has elastic engagement members 43 provided on the decorative plate 42, and positioning holes matching with the elastic engagement members 43 are provided on the door main body 100.

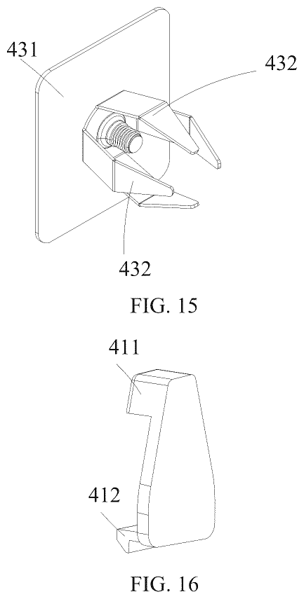

As shown in FIG. 15, the elastic engagement member 43 includes an engagement main body 431 positioned on the decorative plate 42 and multiple elastic snap feet 432 provided on the engagement main body 431. The multiple elastic snap feet 432 are arranged in a ring shape on the engagement main body 431 and have a first state where they converge toward each other and accumulate resilient force. In the first state, the elastic snap feet 432 converge together to allow the elastic engagement member 43 to pass through the positioning hole. After passing through the positioning hole, the accumulated resilient force drives the elastic snap feet 432 to expand and press against the side walls of the positioning hole, thereby positioning the elastic engagement member 43 in the positioning hole and achieving installation and fixing of the elastic engagement member 43 on the door 1.

Installing and fixing the decorative strip 4 through elastic engagement members 43 makes it more convenient to install and remove the decorative strip 4, facilitating replacement. To better achieve installation and fixing of the decorative strip 4, the elastic engagement member 43 and the decorative strip-mounting member 41 are staggered in the front-back direction.

Being staggered in the front-back direction provides two mounting positions for fixing the decorative strip 4 on the door 1, enabling more stable support and fixing of the decorative strip 4 on the door 1.

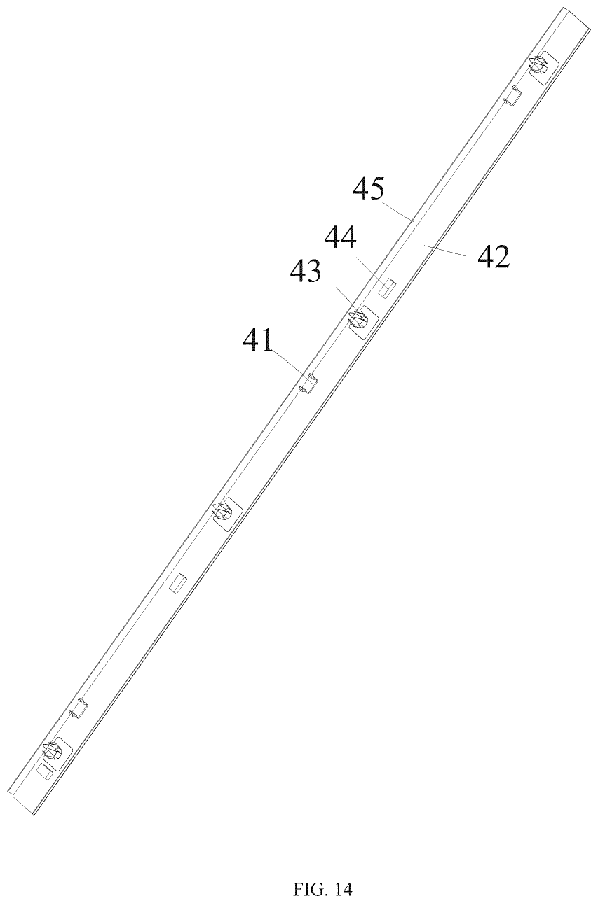

Furthermore, as shown in FIG. 14, magnetic members 44 are also provided on the side of the decorative strip 4 facing the door 1, and magnetic attraction grooves matching with the magnetic members 44 are provided on the door 1.

Since the outer shell of the door 1 is typically made of iron material, providing magnetic members 44 on the decorative strip 4 to magnetically attach to the door 1 facilitates easy installation and fixing of the decorative strip 4 on the door 1.

It can be understood that in specific embodiments, the magnetic members 44 and elastic engagement members 43 do not need to be used simultaneously. They can be used independently, each working with the decorative strip-mounting member 41 separately, or they can be used together to enhance the installation stability of the decorative strip 4.

As shown in FIGS. 7 and 14, the decorative strip 4 has a decorative plate 42 provided on the side of the door 1 and a front cover plate 45 perpendicular to the decorative plate 42. The front cover plate 45 is located at the front side of the door 1 and is arranged parallel to the mounting-fixing plate 33.

The parallel arrangement of the front cover plate 45 and mounting-fixing plate 33 together covers the mounting groove 10, effectively concealing it. After covering the mounting groove 10, they effectively compensate for the reduction in door thickness caused by the mounting groove 10, thereby reducing the impact on refrigerator insulation caused by the mounting groove 10.

The panel 2 is positioned on the front side of the front cover plate 45 and completely covers the front cover plate 45 in the front direction. Covering the front cover plate 45 with panel 2 avoids exposing the decorative plate 4 in the front direction, making the refrigerator more aesthetically pleasing from the front view.

As shown in FIGS. 2-5, to achieve more stable installation and fixing of the panel 2, the door 1 also has an upper beam 1001 provided at the top and bottom of the door main body 100; the upper beam 1001 is provided with bolts 1003 extending in the up-down direction.

The panel 2 also has an upper connecting plate 5 and a lower connecting plate oppositely arranged in the up-down direction on the side facing the door. Bothe the upper connecting plate 5 and the lower connecting plate have connecting plate positioning holes that open in a direction away from the panel 2; the connecting plate positioning holes match with the bolts 1003.

A pair of nuts 1002 are provided on the bolt 1003, and the upper connecting plate 5 is clamped and fixed by the pair of nuts 1002. Using a pair of nuts 1002 to clamp and fix the upper connecting plate 5 also makes it more convenient to adjust the position of the upper connecting plate 5.

The above detailed description of the construction, features, and effects of the present application is based on the embodiments shown in the drawings. The above description is only preferred embodiments of the present application. However, the scope of implementation is not limited to what is shown in the drawings. Any changes made according to the concept of this application, or modifications made as equivalent implementations, as long as they do not exceed the spirit covered by the specification and drawings, should all be within the protection scope of this application.

1. A refrigeration appliance, comprising: a cabinet, a door mounted on the cabinet, and a panel mounted on a front side of the door;
wherein a plurality of mounting grooves are provided on the door and open toward the panel,
wherein a plurality of mounting members are provided on a side of the panel facing the door, the mounting members are positioned in the mounting grooves.

2. The refrigeration appliance according to claim 11, wherein door-mounting holes are provided on the side walls, mounting plate-mounting holes matching with the door-mounting holes are provided on the lateral mounting plates; the mounting plate-mounting holes are opposite to the lateral openings; the lateral mounting plates are fixed to the side walls by fasteners, and the fasteners are simultaneously positioned in the door-mounting holes and the mounting plate-mounting holes.

3. The refrigeration appliance according to claim 1, wherein the mounting groove has an upper wall and a lower wall oppositely arranged in an up-down direction; the mounting member has a bottom plate supported on the lower wall, and positioning protrusions are provided on the lower wall, and positioning slots matching with the positioning protrusions are provided on the bottom plate.

4. The refrigeration appliance according to claim 3, wherein a portion of the lower wall of the mounting groove located at a front side of the positioning protrusion forms an overlap portion, and a plane where the overlap portion is located extends horizontally.

5. The refrigeration appliance according to claim 3, wherein the positioning protrusion has an inclined guide portion inclined toward an opening direction of the mounting groove, and a height of the inclined guide portion gradually increases away from the opening of the mounting groove.

6. The refrigeration appliance according to claim 3, wherein a lateral opening is provided on a side of the door to expose the mounting grooves; the mounting groove has a side wall opposite to the lateral opening; and have lateral mounting plates opposite to the side walls, and the lateral mounting plates are fixed to the side walls; a dimension from a top of the lateral mounting plate to the upper wall is not less than a distance from a top of the positioning protrusion to the lower wall.

7. The refrigeration appliance according to claim 3, wherein a lateral opening is provided on a side of the door to expose the mounting grooves; the mounting groove has a side wall opposite to the lateral opening; and have lateral mounting plates opposite to the side walls, and the lateral mounting plates are fixed to the side walls; the mounting member further has lateral support portions provided on opposite sides of the bottom plate, and a pair of lateral limiting portions are provided in the mounting groove to be opposite to the lateral support portions and limit the lateral support portions in a left-right direction;
wherein the lateral support portion includes a connecting plate provided on one side of the bottom plate and a transverse support plate provided on the connecting plate, the connecting plate is configured to abut against a side wall of the lateral limiting portion, and the transverse support plate is supported on a top of the lateral limiting portion;
wherein the connecting plate is fixedly connected with the lateral mounting plate;
wherein arcuate transition portions are provided between the bottom plate and the connecting plate, and between the connecting plate and the transverse support plate;
wherein the bottom plate, the connecting plate and the transverse support plate are integrally formed.

8. The refrigeration appliance according to claim 1, wherein the door includes a door main body, an upper beam and lower beam, the upper beam is provided on top of the door main body, and the lower beam is provided on bottom of the door main body; bolts extending in an up-down direction are provided on both the upper beam and the lower beam;
wherein the panel further has an upper connecting plate and lower connecting plate oppositely arranged in the up-down direction on a side facing the door, both the upper connecting plate and the lower connecting plate have connecting plate positioning holes; the connecting plate positioning holes match with the bolts;
wherein a pair of nuts are provided on the bolt, and the connecting plate is clamped and fixed by the pair of nuts.

9. The refrigeration appliance according to claim 11, wherein the door includes a door main body and a door-mounting member provided on the door main body, the mounting grooves are provided on the door-mounting member, and the door-mounting member is integrally injection molded;
wherein the lateral opening is provided on the door-mounting member, and the refrigeration appliance further has decorative strips provided on left and right sides of the door main body, decorative strip-mounting members are provided on a side of the decorative strips facing the door main body, the decorative strip-mounting members are opposite to the lateral openings and positioned on the door-mounting member;
wherein decorative strip positioning slots are provided on the decorative strip-mounting members at positions of the lateral openings, opening directions of the decorative strip positioning slots are perpendicular to opening directions of the mounting grooves, and the decorative strip positioning slots are exposed toward the mounting grooves; the decorative strip-mounting members have elastic snap feet engaged in the decorative strip positioning slots.

10. The refrigeration appliance according to claim 9, wherein the decorative strips further have elastic engagement members on a side facing the door main body, positioning holes matching with the elastic engagement members are provided on the door main body, the elastic engagement member includes an engagement main body positioned on the decorative strip and a plurality of elastic snap feet provided on the engagement main body, the plurality of elastic snap feet are arranged in a ring shape on the engagement main body and have a first state where they converge toward each other and accumulate resilient force.

11. The refrigeration appliance according to claim 1, wherein a lateral opening is provided on a side of the door to expose the mounting grooves; the mounting groove has a side wall opposite to the lateral opening; and have lateral mounting plates opposite to the side walls, and the lateral mounting plates are fixed to the side walls.
